(19) United States
(12) Patent Application Publication
(10) Pub. No.: US 2026/0129687 A1
(43) Pub. Date: May 7, 2026

(54) TIMING ADVANCE PRE-COMPENSATION FOR A RANDOM ACCESS PROCEDURE

(71) Applicant: Nokia Technologies Oy, Espoo (FI)

(72) Inventors: Smita SHETTY, Bengaluru (IN); Sami-Jukka HAKOLA, Oulu (FI)

(21) Appl. No.: 19/376,395

(22) Filed: Oct. 31, 2025

(30) Foreign Application Priority Data
Nov. 1, 2024 (IN) 202441083737

(51) Int. Cl. H04W 74/0833; H04W 48/10

(52) U.S. Cl. CPC H04W 74/0833; H04W 48/10

(57) ABSTRACT

Example embodiments of the present disclosure are directed to timing advance (TA) pre-compensation in a random access procedure. A method comprises obtaining configuration information associated with at least a timing advance (TA) pre-compensation capability; determining whether a difference between a current location of the first apparatus with its previous location is below a threshold based on the configuration information; and transmitting, to a second apparatus, a message comprising a random access preamble and uplink data using a timing advance (TA) value of the previous location in response to the difference is below the threshold.

### FIELD

Various example embodiments of the present disclosure generally relate to the field of telecommunication and in particular, to methods, devices, apparatuses and computer readable storage medium for timing advance (TA) pre-compensation for a random access procedure.

### BACKGROUND

5G NR (New Radio) is the next-generation radio access technology developed by the 3rd Generation Partnership Project (3GPP) for the 5G mobile network. It is designed to be the global standard for the air interface of 5G networks, offering lower latency, higher system capacity, and massive device connectivity. Random Access (RA) in 5G NR (New Radio) is a fundamental procedure that enables user equipment (UE) to establish a connection with the network. It is used for various purposes, including initial network access, mobility, and handover. The RA process ensures that UEs can communicate with the base station (gNB) efficiently and reliably, facilitating seamless connectivity and optimal network performance. Looking ahead to 6G, RA technology is expected to evolve to support even more advanced use cases and massive connectivity requirements.

### SUMMARY

In a first aspect of the present disclosure, there is provided a first apparatus. The first apparatus comprises at least one processor; and at least one memory storing instructions that, when executed by the at least one processor, cause the first apparatus at least to: obtain configuration information associated with at least a timing advance (TA) pre-compensation capability; determine a transmission TA in response to determining that a TA pre-compensation capability is supported by the first apparatus based at least on the configuration information, select a random-access (RA) procedure for transmission in response to determining that at least one condition is met; and transmit, to a second apparatus, a message comprising a random access preamble and uplink data using the determined transmission TA and selected random-access procedure.

In a second aspect of the present disclosure, there is provided a second apparatus. The second apparatus comprises at least one processor; and at least one memory storing instructions that, when executed by the at least one processor, cause the first apparatus at least to: transmit, to a first apparatus, configuration information associated with at least a timing advance (TA) pre-compensation capability; and receive, from the first apparatus, a message comprising a random access preamble and uplink data transmitted using a transmission TA determined in response to determining that a TA pre-compensation capability is supported by the first apparatus based at least on the configuration information.

In a third aspect of the present disclosure, there is provided a first apparatus. The third apparatus comprises at least one processor; and at least one memory storing instructions that, when executed by the at least one processor, cause the first apparatus at least to: obtain configuration information associated with at least a timing advance (TA) pre-compensation capability; determine whether a difference between a current location of the first apparatus with its previous location is below a threshold based on the configuration information; and transmit, to a second apparatus, a message comprising a random access preamble and uplink data using a TA value of the previous location in response to the difference is below the threshold.

In a fourth aspect of the present disclosure, there is provided a method. The method comprises: obtaining configuration information associated with at least a timing advance (TA) pre-compensation capability; determining a transmission TA in response to determining that a TA pre-compensation capability is supported by the first apparatus based at least on the configuration information; selecting a random-access (RA) procedure for transmission in response to determining that at least one condition is met; and transmitting, to a second apparatus, a message comprising a random access preamble and uplink data using the determined transmission TA and selected random-access procedure.

In a fifth aspect of the present disclosure, there is provided a method. The method comprises: transmitting, to a first apparatus, configuration information associated with at least a timing advance (TA) pre-compensation capability; and receiving, from the first apparatus, a message comprising a random access preamble and uplink data transmitted using a transmission TA determined in response to determining that a TA pre-compensation capability is supported by the first apparatus based at least on the configuration information.

In a sixth aspect of the present disclosure, there is provided a method. The method comprises: obtaining configuration information associated with at least a timing advance (TA) pre-compensation capability; determining whether a difference between a current location of the first apparatus with its previous location is below a threshold based on the configuration information; and transmitting, to a second apparatus, a message comprising a random access preamble and uplink data using a TA value of the previous location in response to the difference is below the threshold.

In a seventh aspect of the present disclosure, there is provided a first apparatus. The first apparatus comprises means for obtaining configuration information associated with at least a timing advance (TA) pre-compensation capability; means for determining a transmission TA in response to determining that a TA pre-compensation capability is supported by the first apparatus based at least on the configuration information; means for selecting a random-access (RA) procedure for transmission in response to determining that at least one condition is met; and means for transmitting, to a second apparatus, a message comprising a random access preamble and uplink data using the determined transmission TA and selected random-access procedure.

In an eighth aspect of the present disclosure, there is provided a second apparatus. The second apparatus comprises means for transmitting, to a first apparatus, configuration information associated with at least a timing advance (TA) pre-compensation capability; and means for receiving, from the first apparatus, a message comprising a random access preamble and uplink data transmitted using a transmission TA determined in response to determining that a TA pre-compensation capability is supported by the first apparatus based at least on the configuration information.

In a ninth aspect of the present disclosure, there is provided a first apparatus. The third apparatus comprises means for obtaining configuration information associated with at least a timing advance (TA) pre-compensation capability; means for determining whether a difference between a current location of the first apparatus with its previous location is below a threshold based on the configuration information; and means for transmitting, to a second apparatus, a message comprising a random access preamble and uplink data using a TA value of the previous location in response to the difference is below the threshold.

In a tenth aspect of the present disclosure, there is provided a computer readable medium. The computer readable medium comprises instructions stored thereon for causing an apparatus to perform at least the method according to the fourth aspect.

In an eleventh aspect of the present disclosure, there is provided a computer readable medium. The computer readable medium comprises instructions stored thereon for causing an apparatus to perform at least the method according to the fifth aspect.

In a twelfth aspect of the present disclosure, there is provided a computer readable medium. The computer readable medium comprises instructions stored thereon for causing an apparatus to perform at least the method according to the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIGS. 2A-2B, illustrate a 4-step RACH procedure and a 2-step RACH procedure;

FIG. 3 illustrates timing alignment of uplink transmission in difference scenarios;

FIG. 4 illustrates an example environment in which embodiments in the present disclosure may be implemented;

FIGS. 5A-5B, illustrate diagrams of an example flow 500 in accordance with some embodiments of the present disclosure;

FIG. 6 illustrates a flowchart of a method implemented at a first apparatus in accordance with some example embodiments of the present disclosure;

FIG. 7 illustrates a flowchart of a method implemented at a second apparatus in accordance with some example embodiments of the present disclosure;

FIG. 8 illustrates a flowchart of a method implemented at a first apparatus in accordance with some example embodiments of the present disclosure;

FIG. 9 illustrates a simplified block diagram of a device that is suitable for implementing example embodiments of the present disclosure; and

FIG. 10 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components /d/ or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “uplink (UL) transmission” may refer any transmission of data from a terminal device to a network device. This includes, but is not limited to, transmissions in the time domain, frequency domain, space domain, code domain, or any combination thereof. Uplink transmission may involve the use of various resources such as physical resource blocks (PRBs), subcarriers, and time slots, enabling communication from the terminal device to the network device.

As used herein, the term “downlink (DL) transmission” may refer to any transmission of data from a network device to a terminal device. This includes, but is not limited to, transmissions in the time domain, frequency domain, space domain, code domain, or any combination thereof. Downlink transmission may involve the use of various resources such as physical resource blocks (PRBs), subcarriers, and time slots, enabling communication from the network device to the terminal device.

As used herein, the term “random access procedure” may refer to any process by which a terminal device initiates communication with a network device. This includes, but is not limited to, transmissions in the time domain, frequency domain, space domain, code domain, or any combination thereof. The random access procedure may involve the use of various resources such as preambles, random access responses, contention resolution messages, and connection establishment signals, enabling communication initiation from the terminal device to the network device. In the following description, the terms “random access procedure”, “RACH” and “RACH procedure” may be used interchangeably.

As used herein, the term “transmission reception point (TRP)” may refer to any point in a wireless communication system that is capable of both transmitting and receiving signals, such as a physical location or antenna array within a base station or network node. A TRP may facilitate communication between a terminal device (e.g., user equipment) and a network device (e.g., a base station or gNB) through transmission and reception of signals, data, or control information. A TRP may operate independently or in coordination with other TRPs to form part of a larger network architecture, such as a distributed or centralized antenna system. Unless explicitly stated, references to a TRP herein may apply to both its transmitting and receiving capabilities, and may include, but are not limited to, any combination of multiple antennas, beamforming systems, or network nodes enabling communication.

As used herein, the term “frequency range” may refer to any portion of the electromagnetic spectrum allocated for communication between a terminal device and a network device. A frequency range may encompass any set of continuous or discrete frequencies used for transmitting or receiving signals in a communication system, for example, a wireless communication system such as 5G NR, LTE, or Wi-Fi. The term may include, but is not limited to, the allocation of frequencies in the low band, mid band, or high band (e.g., sub-6 GHz, millimeter wave, or beyond) and may span across different bands, depending on regional or regulatory requirements. A frequency range may be utilized for various types of communication, including data, control signaling, or synchronization, and may include resources used in conjunction with time, space, or code domains for enabling communication. In the following, unless explicitly stated, a frequency range in both the uplink and downlink direction will be used as an example for describing some embodiments of the present disclosure. It is noted that example embodiments of the present disclosure are equally applicable to other frequency ranges used in different communication systems.

As used herein, the term “frequency range 1(FR 1 )” may refer to a specific frequency range in a wireless communication system, typically encompassing frequencies between 410 MHz and 7.125 GHz. FR1 may be utilized for communication between terminal devices (e.g., user equipment) and network devices (e.g., base stations or gNBs) in 5G or other wireless systems. FR1 may support a wide variety of deployment scenarios, including but not limited to, enhanced mobile broadband, ultra-reliable low-latency communication, and massive machine-type communication. Unless explicitly stated, references to FR1 herein may refer to the entire spectrum within this frequency range or any sub-band therein, depending on the specific implementation and application in a communication system.

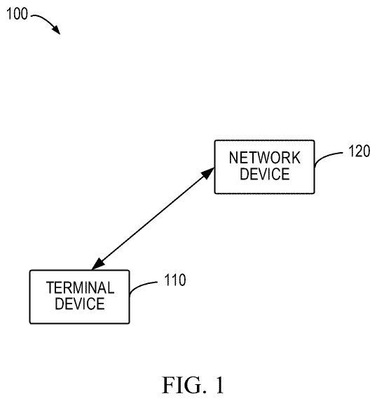

FIG. 1 illustrates an example communication environment 100 in which example embodiments of the present disclosure can be implemented. In the communication environment 100, a plurality of communication devices, including a terminal device 110 and a network device 120, can communicate with each other. In the example of FIG. 1, the terminal device 110 may be a UE and the network device 120 may be a base station serving the UE. The serving area of the network device 120 may be called a cell.

It is to be understood that the number of devices and their connections shown in FIG. 1 are only for the purpose of illustration without suggesting any limitation. The communication environment 100 may include any suitable number of devices configured to implementing example embodiments of the present disclosure. Although not shown, it would be appreciated that one or more additional devices may be located in the cell, and one or more additional cells may be deployed in the communication environment 100. It is noted that although illustrated as a network device, the network device 120 may be another device than a network device. Although illustrated as a terminal device, the terminal device 110 may be another device than a terminal device.

In the following, for the purpose of illustration, some example embodiments are described with the terminal device 110 operating as a UE and the network device 120 operating as a base station. However, in some example embodiments, operations described in connection with a terminal device may be implemented at a network device or other device, and operations described in connection with a network device may be implemented at a terminal device or other device.

In some example embodiments, a transmission direction from the network device 120 to the terminal device 110 is referred to as a downlink (DL), while a transmission direction from the terminal device 110 to the network device 120 is referred to as an uplink (UL). In DL, the network device 120 is a transmitting (TX) device (or a transmitter) and the terminal device 110 is a receiving (RX) device (or a receiver). In UL, the terminal device 110 is a TX device (or a transmitter) and the network device 120 is a RX device (or a receiver).

Communications in the communication environment 100 may be implemented according to any proper communication protocol(s), comprising, but not limited to, cellular communication protocols, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

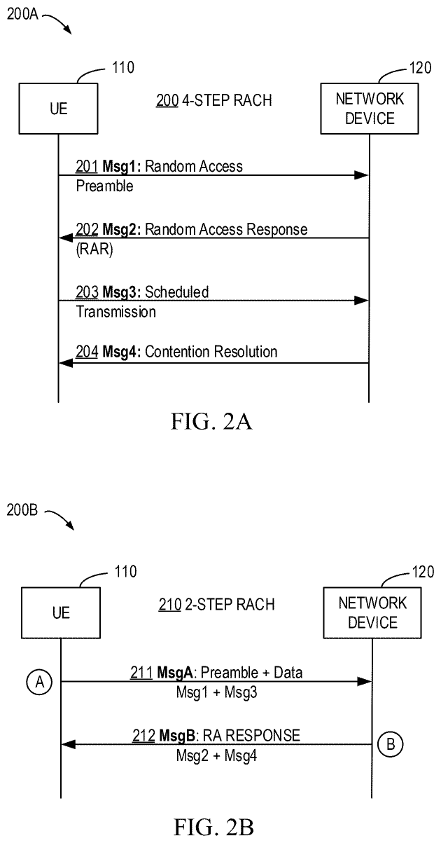

Reference now is made with FIGS. 2A-2B, which illustrate a 4-step RACH procedure 200 and a 2-step RACH procedure 210. Both the 4-step RACH procedure 200 and the 2- step RACH procedure 210 are used in 5G to establish initial communication between a UE 110 and the network device 120. The UE 110 may, for example, be the terminal device 110 and the network device 120 may be the network device 120 in FIG. 1, The 4-step procedure involves four distinct steps 201-204, while the 2-step procedure combines these into two steps 211 and 212.

In the 4-step RACH procedure 200 defined by 5G NR as shown in FIG. 2A, the UE 110 may transmit (201) a random access preamble (Msg1) selected from a set of predefined sequences and this preamble acts as a unique identifier, allowing the network device 120 to recognize the UE's attempt to access the network.

The network device 120 may send (202) a random access response (RAR) message (Msg2) upon receiving the preamble sent by the UE 110. The RAR includes critical information such as timing advance (TA), uplink resource allocation, and a temporary identifier (Temporary C-RNTI) for the UE 110.

The UE 110 may send (203) a scheduled message (Msg3) to the network device 120 using the resources allocated in the RAR which typically contains the UE's identity and other necessary information for the network device 120 to process the access request.

The network device 120 may process the scheduled message and send (204) a contention resolution message (Msg4) to the UE 110, which confirms the successful resolution of any contention and finalizes the connection establishment.

In the 2-step RACH procedure 210 defined by 5G NR as shown in FIG. 2B, UE 110 may combine the Msg1 and Msg3 of the 4-step RACH procedure in a MsgA and send (211) it to the network device 120 without the UE 110 waiting for feedback in between (Msg2). Similarly, the network device 120 may combine Msg2 and Msg4 into MsgB and send (212) it to the UE 110.

As introduced in the above, in the baseline 4-step random access procedure, the UE 110 may send a RACH preamble (Msg1) without the knowledge about the timing advance (TA) during initial access. The network device 120 may process PRACH preamble and estimate a TA required to compensate the round-trip time propagation delay. The network device 120 may then inform the UE 110 about the TA (Msg2). The UE 110 may apply the TA received in Msg2 while sending the Msg3 which is the payload (PUSCH).

To optimize the initial access procedure and ensure that the UE 110 may be able to select the most appropriate RA type based on the signal conditions which helps in improving the efficiency and reliability of the connection establishment process, a threshold ‘MsgA_RSRP_threshold’ (applicable for a synchronization signal block (SSB)) may be pre-configured by the network device 120, which is one of the deciding factors between a choice of a 2-step RACH and a 4-step RACH procedure by the UE 110. This threshold may be broadcasted in the system information block 1 (SIB 1 ) by the network device 120. The UE 110 may attempt the 2-step RACH if the reference signal received power (RSRP) of the measured SSB is higher than the pre-configured threshold, or else it may attempt the 4-step RACH.

6G pre standardization discussions are ongoing and network infrastructure vendors as well as UE vendors are discussing the 6G functionalities that need to be provided/supported from day 1. Major market players agree that the 4-step RACH as a baseline with further enhancements for the 2-step RACH procedure with respect to the random access procedures. In Table 1 below, there are listed the opinions of some major market players. As shown, it is a common understanding that the 4-step and the 2-step RACH will continue to play an important role in future developments of the communication technologies.

In a mobile communication network, a plurality of UEs (for example, the terminal device 110 FIG. 1, or the UE 110 in FIG. 2) may be positioned at different locations with some of the plurality of UEs located close to the gNB (for example, the network device 120 in FIG. 1, or the network device 120 in FIG. 2), some other further away and some right at the edge of a cell. Due to the different locations, the propagation delay experienced by different UEs may be quite different. For example, the difference between the propagation delay experienced by a UE closer to the gNB and a UE at the edge of the cell may in return result that an uplink transmission from the UE close to the gNB reaches the gNB earlier in time compared to an uplink transmission from the UE close to the edge of the cell. To maintain orthogonality, it is important that uplink transmissions from the UEs within the cell may be received at the gNB within the cyclic prefix. In the 4-step RACH procedure, the gNB may send a TA command to a UE, which instructs the UE to transmit in corresponding uplink transmissions earlier in relation to the time of its downlink reception. The UE may first receive a TA value which is absolute during the random access procedure and receives one or more subsequent TA values after the random access procedure which are relative to the absolute TA value received initially during the RACH procedure. The gNB may estimate, based on the sounding reference signal (SRS), physical uplink shared channel (PUSCH), and physical uplink control channel (PUCCH) transmissions received from the UE, the time by which the UE needs to advance its uplink transmissions (i.e., TA value), and then send the TA value via a media access control (MAC) control element (CE). The TA which a UE receives from the gNB in CONNECTED mode has a timer (TimeAlignmentTimer) associated with it, which means that when the timer expires, the TA value is no longer valid, and the UE needs to acquire the TA value again from the gNB via the RACH procedure.

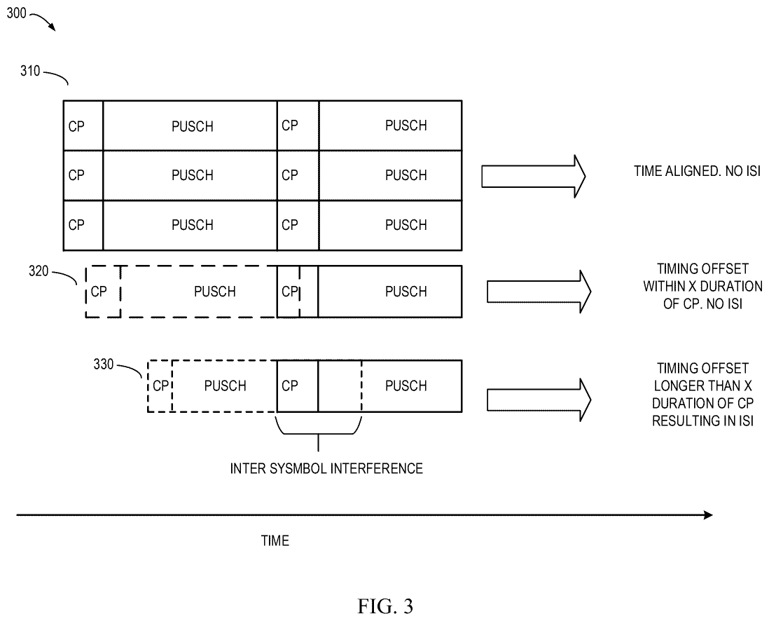

However, a MsgA is sent without any TA in the 2-step RACH procedure as currently defined in 5G NR, which means the respective PUSCH parts of the MsgA is transmitted by various UEs attempting the random access procedure are not time aligned when received at the gNB. This will cause issue at the gNB during demodulation, as ideally the PUSCH transmissions from different UEs should be received at the gNB with the timing misalignment (if any) not exceeding a certain length of the cyclic prefix (CP). In case it does exceed the certain length of the CP, then the PUSCH transmissions from the UEs will interfere with each other and cause inter symbol interference (ISI). This is because that when the PUSCH is received in the gNB, the CP will be removed, and the symbols will be input into a FFT block for processing where the samples are converted from time domain to frequency domain. As the FFT window is fixed, hence the gNB needs to send a TA such that the PUSCH transmissions received by the gNB from various UEs may be received well within the FFT window for processing. However, in the absence of TA in MsgA, the PUSCH transmissions received by the gNB may not be time aligned and hence may cause severe ISI when received beyond the CP (see 330 in FIG. 3).

Reference now is made with FIG. 3, which illustrates timing alignment of uplink transmission in difference scenarios 310, 320 and 330. As shown in FIG. 3, in 310, each PUSCH transmission is aligned with each other, no ISI occurs. In 320, though the PUSCH transmission is received with a timing offset, no ISI occurs as the timing offset is within a certain length of the duration of the CP. As comparison, in 330, ISI occurs (illustrated as “inter symbol interference” in FIG. 3) as the PUSCH transmission is received with a timing offset longer than the certain length of the duration of the CP (in the case of 330, the timing offset is longer than the whole length of the duration of the CP).

One of the ways to mitigate this above-discussed issue is to ensure that only those UEs which are closer to the gNB can use the 2-step RACH procedure so that the timing misalignment of the PUSCH part of the MsgA, if any, may be within the CP. This is done by using the “MsgA_RSRP_threshold” parameter mentioned in the above. However, the drawbacks are obvious as only the UEs within a certain cell range may utilize the 2-step RACH procedure, and the UEs that are farther away from the gNB will have to always use the 4 step RACH procedure.

Embodiments in the present disclosure may enable the utilization of the 2-step RACH procedure by a UE even if the RSRP of the SSB measured by the UE is below the threshold set by the “MsgA_RSRP_threshold” parameter, which means that a UE may attempt a 2-step RACH procedure without causing severe ISI irrespective of the distance of the UE from the network.

Current standard specifically requires that a UE can attempt a 2-step RACH only if the RSRP of the SSB on which it will attempt a 2-step RACH is above the threshold set by “MsgA_RSRP_threshold”, which is configured by the network. This restriction is to ensure only those UEs closer to the gNB may utilize the 2-step RACH such that the timing misalignment of the respective PUSCH parts of the MsgAs, if any, is within the CP. This restrict was also because of the understanding at the time that UEs do not have TA pre-compensation mechanism available. However, with further advancements in UE functionalities such as the support for GNSS capabilities, time sensitive networking (TSN), or positioning features, it is possible for UEs which support these functionalities, to carry out TA pre-compensation. Ideally, the abovementioned restriction does not apply for the UEs with TA pre-compensation capabilities.

The core concept in the present disclosure is that a UE with TA pre-compensation capabilities may use the 2-step RACH irrespective of the distance between the UE and the gNB, thereby ensuring that a larger number of UEs may use the 2-step RACH procedure and avail the latency benefits that such 2-step RACH procedure was originally designed for.

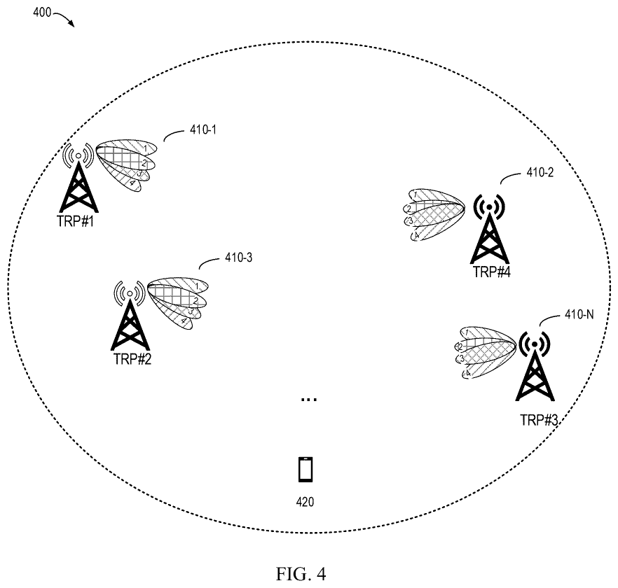

Reference now is made with FIG. 4, which illustrates an example environment in which embodiments in the present disclosure may be implemented. It is understood that the example in FIG. 4 is merely for the purpose of illustration and should not be interpreted as any limitation. As shown in FIG. 4, the example environment uses multiple transmission reception points (m-TRPs) deployment in a frequency range 1(FR 1 ) cell 400. The FR1 cell 400 operates with a subcarrier spacing of, e.g., 30 kHz, allowing for a maximum off 8 synchronization signal blocks (SSBs). In FIG. 4, it is shown four TRPs, 410-1, 410-2, 410-3, . . . , and 410-N (individually or collectively referred to as 410, the TRPs may be for example the network device 120 in FIG. 1, or the network device 120 in FIG. 2), however, there may be fewer or more TRPs. In an implementation, the TRPs 410 may transmit the SSBs in a single frequency network (SFN) manner. A UE 420 (for example, the terminal device 110 in FIG. 1 or the UE 110 in FIG. 2) may attempt to access the network via one of the TRPs 410 in the FR1 cell 400. Though there is shown only one UE 420, it is to be understood there may be more UEs 420 (individually or collectively referred to as 420). If the UE 420 is positioned in a distance far from the TRPs, e.g., close to the edge of the cell 400, the RSRP measured by the UE 420 may probably below the network configured MsgA_RSRP_threshold, which means according to the current standard, UE 420 may not attempt 2-step RACH even it is functionalized with TA pre-compensation capabilities. Embodiments in the present disclosure provides the opportunity for UEs 420 functionalized with TA pre-compensation capabilities to attempt 2-step RACH irrespective of the distance. It is to be understand that embodiments are described with m-TRPs deployment and SFN manner merely as an example and should not be interpreted as any limitation.

The network (for example, a gNB, the network device 120 in FIG. 1 or the network device 120 in FIG. 2) may broadcast, in addition to system information essential for the UE 420 to perform random access, condition information including an indication indicating that a UE capable of 2-step RACH and TA pre-compensation may attempt 2-step RACH even if the RSRP measured is below the network configured MsgA_RSRP_threshold. For ease of reference, the scenario that a UE capable of the 2-step RACH and TA pre-compensation may attempt the 2-step RACH even if the RSRP measured is below the network configured MsgA_RSRP_threshold will be referred to as “the 2-step RACH with TA pre-compensation”. The UE 420 may determine whether the 2-step RACH can be attempted irrespective of its distance to the network according to the indication. Such indication may be in a format of a bit in the system information block (SIB) with a value ‘1’ (or, alternatively ‘0’) indicating the enablement of the support of the 2-step RACH with TA pre-compensation. The UE 420 capable of 2-step RACH and TA pre-compensation may ignore the network configured MsgA_RSRP_threshold if the UE 420 receives the indication indicating that ‘the 2-step RACH with TA pre-compensation” is supported. The indication may be, for example, configured in the RACH_ConfigCommonTwoStepRA information element.

Alternatively, the network need not broadcast the above-discussed information indicating ‘the 2-step RACH with TA pre-compensation” is supported, and only broadcasts information that enables the UE 420 to determine the TA values. Such information may be in the form of gNB positioning information, TA values applicable at different distances, TA values associated with different RSRP ranges, timing synchronization information sent via a system information block (SIB). or the like. In case of a m-TRP scenario (for example, as shown in FIG. 4), such information may be provided per TRP within the cell. For gNB positioning information, the gNB may transmit its own location and positioning information to the UE, which helps the UE estimate their relative distance to the gNB. This distance may then be used by the UE to compute the propagation delay and thereby determine its TA by comparing its location with the gNB location (i.e., TA pre-compensation based on gNB and UE known location). For TA values applicable at different distances, the UE may determine whether its location is still within the distance corresponding to the TA value associated with the distance (i.e., TA pre-compensation based on location change). For timing synchronization information sent via SIB, the UE may estimate the propagation delay and the TA value by comparing its own clock to that broadcasted by the gNB (i.e., TA pre-compensation based on SIB, e.g., SIB9). For TA values associated with different RSRP ranges, the UE receiving a TA value associated with a certain RSRP may apply the TA value based on the RSRP level of the SSB if the RSRP measured by the UE is in the certain RSRP range (i.e., TA pre-compensation based on RSRP). Other than the above-described methods for determining TA pre-compensation, any other methods existing or future-developed may also be adopted.

A downlink synchronised UE 420 may read system information received from the signalling information being broadcasted by the network. The UE 420 may select the SSB beam with the highest RSRP amongst those it can find and measure. Since the TRPs 410 in the cell 400 transmit the SSBs in a SFN manner, the UE 420 at this point is unaware which TRP is transmitting the SSB that the UE has determined as the best one. The UE 420 with TA pre-compensation capabilities may ignore the MsgA_RSRP_threshold in response to, for example, i) the information indicating that ‘the 2-step RACH with TA pre-compensation” is supported, or ii) information that enables the UE 420 to determine its TA is received from the network. The UE 420 may then perform the 2-step RACH, in which the UE 420 may compute the TA values for pre-compensation (e.g., based on information transmitted by the network in SIB, e.g., ReferenceTimeInfo and UTC in SIB9). The computation of TA values for pre-compensation may utilize any existing (e.g., the ones discussed in the above) or future-developed methods. In case of a m-TRP scenario (for example, as shown in FIG. 4), as there are multiple TRPs in the cell 400 transmitting in a SFN manner, the UE 420 may compute a TA value for each TRP. The UE 420 may compare the TA values it has computed for each TRP and select the smallest TA value and transmit the MsgA of the 2-step RACH to the TRP with the smallest TA value (which implies the TRP with the smallest TA value is the one that is closest to the TRP).

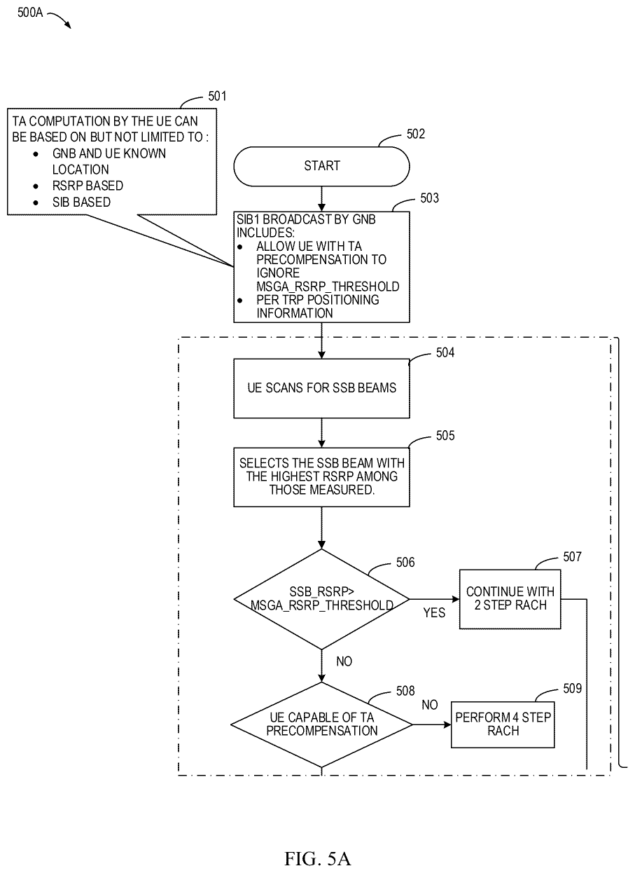

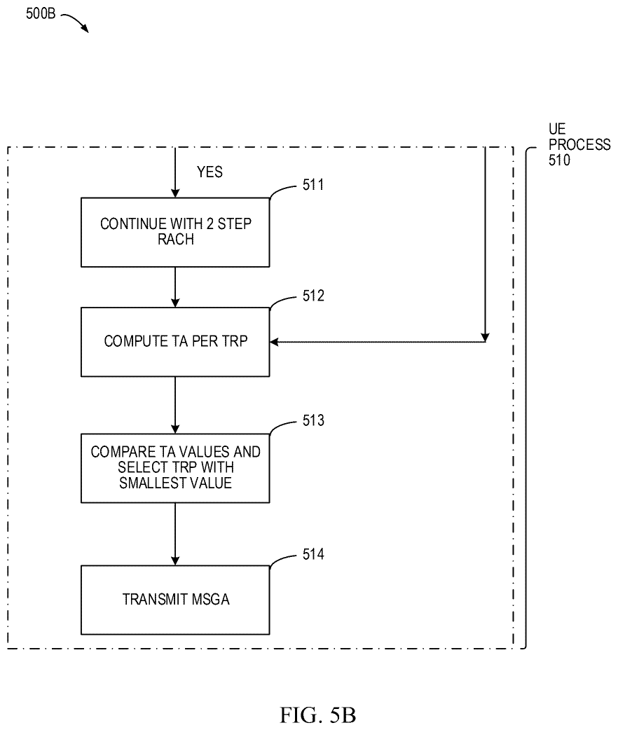

In summary, the UE 420 may perform a 2-step RACH if any of the following conditions is met, 1) the UE 420 support TA pre-compensation capability, 2) an estimated received signal strength is below the MsgA_RSRP_threshold and the UE 420 supports TA pre-compensation capability, or 3) a determined change of location of the UE 420 is within a granularity of TA adjustment. Details of the above conditions will be described with reference to FIGS. 5A-5B.

Reference now is made with FIGS. 5A-5B, which illustrate diagrams of an example flow 500 in accordance with some embodiments.

At block 503, the network (e.g., a gNB, the network device 120 in FIG. 1, or the network device 120 in FIG. 2) broadcasts configuration information associated with TA pre-compensation capability, among which information enabling a UE with TA pre-compensation capabilities (e.g., the terminal device 110 in FIG. 1, the UE 110 in FIG. 2, or the UE 420 in FIG. 4) to determine a pre-compensating TA value may be included. The information enabling a UE with TA pre-compensation capabilities to determine a pre-compensating TA value may include information based on which the UE may compute the propagation delay between the UE and the network device hence corresponding TA value may be determined. As aforementioned, such information may be in the form of gNB positioning information (i.e., TA pre-compensation based on gNB and UE known location), TA values applicable at different distances (i.e., TA pre-compensation based on location change), TA values associated with different RSRP ranges (i.e., TA pre-compensation based on RSRP), timing synchronization information sent via a SIB (i.e., TA pre-compensation based on SIB) or the like (see block 501). The configuration information may also comprise random access configuration information at least comprising 2-step RA and 4-step RA and a reference signal received power (RSRP) threshold value (e.g., the MsgA_RSRP_threshold), aside from the enabling a UE with TA pre-compensation capabilities to determine a pre-compensating TA value. The configuration information may further include an indication indicating a UE with TA pre-compensation capabilities may ignore the threshold, e.g., MsgA_RSRP_threshold, configured by the network for performing the 2-step RACH, e.g., by transmitting MsgA. The indication may be in a format of a bit in the system information block (SIB) with a value ‘1’ (or, alternatively ‘0’) indicating the enablement of the support of the 2-step RACH with TA pre-compensation. In some embodiments, the information may not include the indication, which means the indication is optional.

At block 504, the UE may scan for synchronization signal block (SSB) beams during which the UE may scan for SSB beams to detect, time-synchronize, and acquire essential parameters from the cell.

At block 505, the UE may select the SSB beam with the highest RSRP amongst those it can find and measure. Again, in a scenario where a plurality of TRPs transmitting the SSBs in a SFN manner, the UE is unaware of which TRP is transmitting the SSB that the UE has determined as the best one.

At block 506, it is determined whether the measured respective RSRPs of the SSB beams are above the threshold (MsgA_RSRP_threshold) configured by the network, and if yes (the branch ‘YES’ of block 506), the UE may perform the 2-step RACH in accordance with current standard at block 507. If, however, none of the measured respective RSRPs of the SSB beams are above the threshold (MsgA_RSRP_threshold) configured by the network (the branch ‘NO’ of block 506), the UE functionalized with TA pre-compensation capabilities (the branch ‘YES’ of the block 508) may ignore the threshold and read, from e.g., SIBs, information enabling the UE to determine the TA values and continue with the 2-step RACH at block 511. If, however, the UE is not functionalized with TA pre-compensation capabilities (the branch ‘NO’ of block 508), the 4-step RACH may be performed by the UE at block 509.

At block 512, the UE may compute, based on the information received from the broadcast of the network (i.e., information based on which the UE may compute the propagation delay between the UE and the network device hence corresponding TA value may be determined), respective TA values of the TRPs.

At block 513, the UE may compare the computed TA values and select the TRP associated with the smallest TA value, i.e., the TRP with the smallest TA value is the one that is closest to the TRP). And at block 514, the UE may transmit MsgA using the selected TA to the associated TRP.

From UE perspective, a UE previously received TA via the timing advance command from the gNB when in RRC_CONNECTED mode may store the TA value when it transforms from CONNECTED to IDLE or INACTIVE mode. When such a UE (supporting TA pre-compensation) in IDLE or INACTIVE mode, the UE may be able to perform the 2-step RACH with the information broadcasted by the network enabling the UE to determine a pre-compensating TA. Based on the information, the UE may determine whether a difference between a current location of the UE with its previous location is below a threshold. The threshold is a maximum distance of a location change of the first apparatus below which the TA value needs not adjusting. For example, the distance of the threshold may correspond to the granularity of the TA adjustment, e.g., for 15 KHz subcarrier spacing (SCS), the granularity of TA adjustment is ˜78.06 meters (i.e., a change of one step of TA corresponds to ˜78.06 meters).

As discussed in the above, the information enabling the UE to determine a pre-compensating TA may be selected from 1) positioning information of the network device, 2) TA values at different distances, 3) TA values associated with different reference signal received power (RSRP) ranges, or 4) timing synchronization information sent via SIB, or the like. Whether the difference between the current location and its previous location is below a threshold may be determined based on the information above. For example, it may be determined that the difference is below the threshold in response to the current location is within the distance of the threshold of its previous location, in response to the TA value at the current location is the same as the TA value at its previous location, or in response to TA value at the RSRP level at the current location is the same as the RSRP level at its previous location. The UE may perform the 2-step RACH in response to the difference between the current location and its previous location is below the threshold irrespective of the received signal strength, i.e., the UE may still perform the 2-step RACH even the measured RSRP is below the MsgA_RSPR_threshold configured by the network.

There may be three example scenarios:
Scenario 1: the UE may determine that the difference is below the threshold by determining its location has not changed based on the information broadcasted by the network, e.g., the position co-ordinates, or SSB_RSRP of the beam (e.g., beam #x) the UE used when it obtained the TA when in the CONNECTED mode. As the location has not changed, the UE may use the stored earlier TA value (which it received when in CONNECTED mode) when transmitting the MsgA of the 2-step RACH using the same beam (beam #x). This will result in a perfect timing alignment when the MsgA is received at the network device.
Scenario 2: the UE may find another beam (beam #y) with a better RSRP than beam #x the UE used when in CONNECTED mode. The UE may still use beam #x to transmit the MsgA of the 2-step RACH using the stored earlier TA value (which it received when in CONNECTED mode).
Scenario 3: the UE has moved a certain distance, but the difference is still below the threshold. For example, for 15 KHz SCS, less than ˜78.06 meters (the granularity of TA adjustments). The UE may still use the stored earlier TA value (which it received when in CONNECTED mode) to transmit the MsgA of the 2-step RACH.

Though example scenarios are described in the above, they are merely for the purpose of illustration, there may be other scenarios as long as the UE support TA pre-compensation and the information broadcasted by the network enables the UE to determine a pre-compensating TA. The above example should not be interpreted as any limitations.

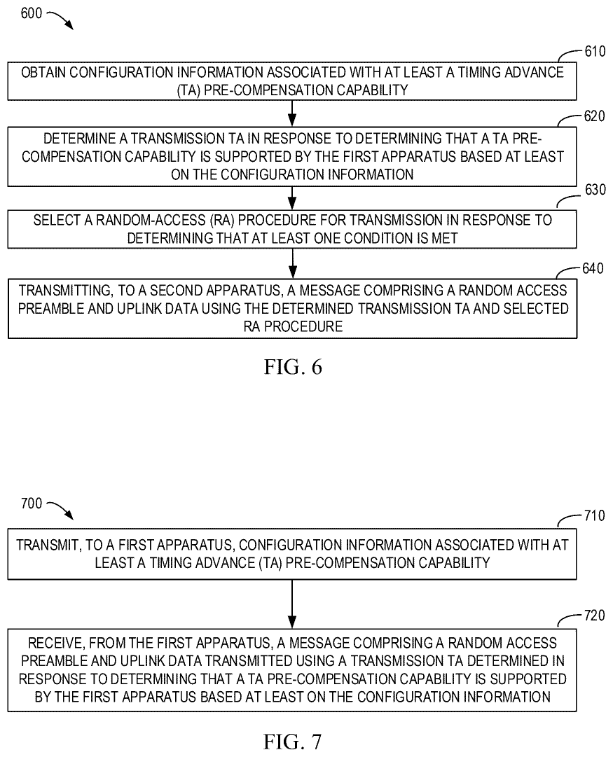

FIG. 6 shows a flowchart of an example method 600 implemented at a first apparatus in accordance with some example embodiments of the present disclosure. For the purpose of discussion, the method 600 will be described from the perspective of the terminal device 110 in FIG. 1 (the UE 110 in FIGS. 2A-2B, or the UE 420 in FIG. 4).

At block 610, obtaining configuration information associated with at least a timing advance (TA) pre-compensation capability.

At block 620, determining a transmission TA in response to determining that a TA pre-compensation capability is supported by the first apparatus based at least on the configuration information.

At block 630, selecting a random-access (RA) procedure for transmission in response to determining that at least one condition is met.

At block 640, transmitting, to a second apparatus, a message comprising a random access preamble and uplink data using the determined transmission TA and selected random-access procedure.

In some example embodiments, the configuration information comprises at least one of the following: capability information indicative of a capability of the apparatus to support TA pre-compensation; random access configuration information at least comprising 2-step RA and 4-step RA; a reference signal received power (RSRP) threshold value;-information enabling the first apparatus to determine the transmission TA; or condition information associated with RA selection.

In some example embodiments, the at least one condition comprises at least one of the following: the TA pre-compensation capability is supported by the first apparatus; an estimated received signal strength is below the RSRP threshold value and the TA pre-compensation capability is supported by the first apparatus; or a determined change of location of the first apparatus being within a granularity of TA adjustment.

In some example embodiments, the configuration information is received as part of a system information block, or broadcasting signals.

In some example embodiments, the information enabling the first apparatus to determine the transmission TA comprises parameter information for the first apparatus to compute a propagation delay between the first apparatus and the second apparatus.

In some example embodiments, the parameter information comprises at least one of the following: positioning information of the second apparatus; TA values at different distances; TA values associated with different reference signal received power (RSRP) ranges; or timing synchronization information.

In some example embodiments, the condition information associated with RA selection comprises an indication indicating the RSRP threshold is able to be ignored if the TA pre-compensation capability is supported by the first apparatus, and the transmission of the message comprising the random access preamble and the uplink data is further in response to receiving the indication.

In some example embodiments, the method 600 further comprises: determining a received signal strength; wherein the determination of the transmission TA is in response to receiving the indication and the determined received signal strength being below the RSRP threshold.

In some example embodiments, the RSRP threshold indicates a minimum received signal strength for the first apparatus to transmit the message comprising the random access preamble and the uplink data if the TA pre-compensation capability is not supported by the first apparatus.

In some example embodiments, the first apparatus is or is comprised in a terminal device, and wherein the second apparatus is or is comprised in a network device.

FIG. 7 shows a flowchart of an example method 700 implemented at a second apparatus in accordance with some example embodiments of the present disclosure. For the purpose of discussion, the method 700 will be described from the perspective of the terminal device 110 in FIG. (the UE 110 in FIGS. 2A-2B, or the UE 420 in FIG. 4).

At block 710, transmitting, to a first apparatus, configuration information associated with at least a timing advance (TA) pre-compensation capability.

At block 720, receiving, from the first apparatus, a message comprising a random access preamble and uplink data transmitted using a transmission TA determined in response to determining that a TA pre-compensation capability is supported by the first apparatus based at least on the configuration information.

In some example embodiments, the configuration information comprises at least one of the following: random access configuration information at least comprising 2-step RA and 4-step RA; a reference signal received power (RSRP) threshold value; information enabling the first apparatus to determine the transmission TA; or condition information associated with RA selection.

In some example embodiments, the configuration information is transmitted as part of a system information block, or broadcasting signals.

In some example embodiments, the information enabling the first apparatus to determine the transmission TA comprises parameter information for the first apparatus to compute a propagation delay between the first apparatus and the second apparatus.

In some example embodiments, the parameter information comprises at least one of the following: positioning information of the second apparatus; TA values at different distances; TA values associated with different reference signal received power (RSRP) ranges; or timing synchronization information.

In some example embodiments, the condition information associated with RA selection comprises an indication indicating the RSRP threshold is able to be ignored if the TA pre-compensation capability is supported by the first apparatus.

In some example embodiments, the first apparatus is or is comprised in a terminal device, and wherein the second apparatus is or is comprised in a network device.

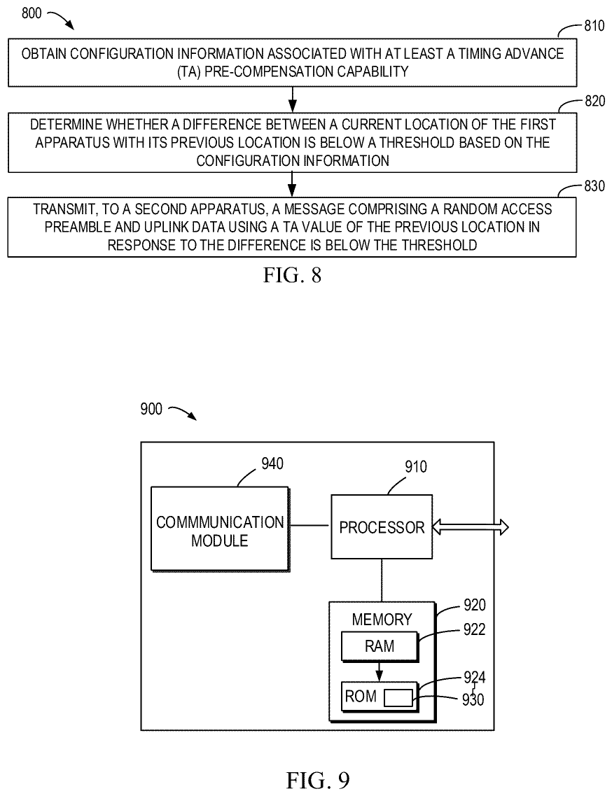

FIG. 8 shows a flowchart of an example method 800 implemented at a first apparatus in accordance with some example embodiments of the present disclosure. For the purpose of discussion, the method 800 will be described from the perspective of the terminal device 110 in FIG. 1 (the UE 110 in FIGS. 2A-2B, or the UE 420 in FIG. 4).

At block 810, obtaining configuration information associated with at least a timing advance (TA) pre-compensation capability.

At block 820, determining whether a difference between a current location of the first apparatus with its previous location is below a threshold based on the configuration information.

At block 830, transmitting, to a second apparatus, a message comprising a random access preamble and uplink data using a TA value of the previous location in response to the difference is below the threshold.

In some example embodiments, the method 800 further comprises: transmitting the message comprising the random access preamble and the uplink data using the beam used by the first apparatus in its previous location.

In some example embodiments, the threshold is a maximum distance of a location change of the first apparatus below which the TA value needs not adjusting.

In some example embodiments, the configuration information comprises at least one of the following: capability information indicative of a capability of the apparatus to support TA pre-compensation; random access configuration information at least comprising 2-step RA and 4-step RA; a reference signal received power (RSRP) threshold value; information enabling the first apparatus to determine the transmission TA; or condition information associated with RA selection.

In some example embodiments, the configuration information is received as part of a system information block, or broadcasting signals

In some example embodiments, the information enabling the first apparatus to determine the transmission TA comprises parameter information for the first apparatus to compute a propagation delay between the first apparatus and the second apparatus.

In some example embodiments, the parameter information comprises at least one of the following: positioning information of the second apparatus; TA values at different distances; TA values associated with different reference signal received power (RSRP) ranges; or timing synchronization information.

In some example embodiments, the condition information associated with RA selection comprises an indication indicating the RSRP threshold is able to be ignored if the TA pre-compensation capability is supported by the first apparatus, and the transmission of the message comprising the random access preamble and the uplink data is further in response to receiving the indication.

In some example embodiments, whether the difference between the current location of the first apparatus with its previous location is below the threshold is determined based on the positioning information of the second apparatus; and it is determined that the difference is below the threshold in response to the current location is within the distance of the threshold of its previous location.

In some example embodiments, the distance of the threshold is the granularity of the TA adjustment.

In some example embodiments, whether the difference between the current location of the first apparatus with its previous location is below the threshold is determined based on the TA value at the current location and the TA value at its previous location; and it is determined that the difference is below the threshold in response to the TA value at the current location is the same as the TA value at its previous location.

In some example embodiments, whether the difference between the current location of the first apparatus with its previous location is below the threshold is determined based on the TA values associated with different RSRP ranges; and it is determined that the difference is below the threshold in response to TA value at the RSRP level at the current location is the same as the RSRP level at its previous location.

In some example embodiments, the TA value of the previous location is obtained from the second apparatus while the first apparatus was in CONNECTED mode.

In some example embodiments, the first apparatus is in an IDLE mode or INACTIVE mode.

In some example embodiments, the first apparatus is or is comprised in a terminal device, and wherein the second apparatus is or is comprised in a network device.

In some example embodiments, a first apparatus capable of performing any of the method 600 (for example, the terminal device 110 in FIG. 1 (the UE 110 in FIGS. 2A-2B, or the UE 420 in FIG. 4)) may comprise means for performing the respective operations of the method 600. The means may be implemented in any suitable form. For example, the means may be implemented in a circuitry or software module. The first apparatus may be implemented as or included in the terminal device 110 in FIG. 1 (the UE 110 in FIGS. 2A-2B, or the UE 420 in FIG. 4).

In some example embodiments, the first apparatus comprises means for obtaining configuration information associated with at least a timing advance (TA) pre-compensation capability; means for determining a transmission TA in response to

determining that a TA pre-compensation capability is supported by the first apparatus based at least on the configuration information; means for selecting a random-access (RA) procedure for transmission in response to determining that at least one condition is met; and means for transmitting, to a second apparatus, a message comprising a random access preamble and uplink data using the determined transmission TA and selected random-access procedure.

In some example embodiments, the configuration information comprises at least one of the following: capability information indicative of a capability of the apparatus to support TA pre-compensation; random access configuration information at least comprising 2-step RA and 4-step RA; a reference signal received power (RSRP) threshold value; information enabling the first apparatus to determine the transmission TA; or condition information associated with RA selection.

In some example embodiments, the at least one condition comprises at least one of the following: the TA pre-compensation capability is supported by the first apparatus;-an estimated received signal strength is below the RSRP threshold value and the TA pre-compensation capability is supported by the first apparatus; or a determined change of location of the first apparatus being within a granularity of TA adjustment.

In some example embodiments, the configuration information is received as part of a system information block, or broadcasting signals.

In some example embodiments, the information enabling the first apparatus to determine the transmission TA comprises parameter information for the first apparatus to compute a propagation delay between the first apparatus and the second apparatus.

In some example embodiments, the parameter information comprises at least one of the following: positioning information of the second apparatus; TA values at different distances; TA values associated with different reference signal received power (RSRP) ranges; or timing synchronization information.

In some example embodiments, the condition information associated with RA selection comprises an indication indicating the RSRP threshold is able to be ignored if the TA pre-compensation capability is supported by the first apparatus, and the transmission of the message comprising the random access preamble and the uplink data is further in response to receiving the indication.

In some example embodiments, the first apparatus further comprises: means for determining a received signal strength; wherein the determination of the transmission TA is in response to receiving the indication and the determined received signal strength being below the RSRP threshold.

In some example embodiments, the RSRP threshold indicates a minimum received signal strength for the first apparatus to transmit the message comprising the random access preamble and the uplink data if the TA pre-compensation capability is not supported by the first apparatus.

In some example embodiments, the first apparatus is or is comprised in a terminal device, and wherein the second apparatus is or is comprised in a network device.

In some example embodiments, a second apparatus capable of performing any of the method 700 (for example, the network device 120 in FIG. 1 (the network device 120 in FIGS. 2A-2B, or the TRP 410 in FIG. 4)) may comprise means for performing the respective operations of the method 700. The means may be implemented in any suitable form. For example, the means may be implemented in a circuitry or software module. The second apparatus may be implemented as or included in the network device 120 in FIG. 1 (the network device 120 in FIGS. 2A-2B, or the TRP 410 in FIG. 4).

In some example embodiments, the second apparatus comprises means for transmitting, to a first apparatus, configuration information associated with at least a timing advance (TA) pre-compensation capability; and means for receiving, from the first apparatus, a message comprising a random access preamble and uplink data transmitted using a transmission TA determined in response to determining that a TA pre-compensation capability is supported by the first apparatus based at least on the configuration information.

In some example embodiments, the configuration information comprises at least one of the following: random access configuration information at least comprising 2-step RA and 4-step RA; a reference signal received power (RSRP) threshold value; information enabling the first apparatus to determine the transmission TA; or condition information associated with RA selection.

In some example embodiments, the configuration information is transmitted as part of a system information block, or broadcasting signals.

In some example embodiments, the information enabling the first apparatus to determine the transmission TA comprises parameter information for the first apparatus to compute a propagation delay between the first apparatus and the second apparatus.

In some example embodiments, the parameter information comprises at least one of the following: positioning information of the second apparatus; TA values at different distances; TA values associated with different reference signal received power (RSRP) ranges; or timing synchronization information.

In some example embodiments, the condition information associated with RA selection comprises an indication indicating the RSRP threshold is able to be ignored if the TA pre-compensation capability is supported by the first apparatus.

In some example embodiments, the first apparatus is or is comprised in a terminal device, and wherein the second apparatus is or is comprised in a network device.

In some example embodiments, a first apparatus capable of performing any of the method 800 (for example, the terminal device 110 in FIG. 1 (the UE 110 in FIGS. 2A-2B, or the UE 420 in FIG. 4)) may comprise means for performing the respective operations of the method 800. The means may be implemented in any suitable form. For example, the means may be implemented in a circuitry or software module. The first apparatus may be implemented as or included in the terminal device 110 in FIG. 1 (the UE 110 in FIGS. 2A-2B, or the UE 420 in FIG. 4).

In some example embodiments, the first apparatus comprises means for obtaining configuration information associated with at least a timing advance (TA) pre-compensation capability; means for determining whether a difference between a current location of the first apparatus with its previous location is below a threshold based on the configuration information; and means for transmitting, to a second apparatus, a message comprising a random access preamble and uplink data using a TA value of the previous location in response to the difference is below the threshold.

In some example embodiments, the first apparatus further comprises: means for transmitting the message comprising the random access preamble and the uplink data using the beam used by the first apparatus in its previous location.

In some example embodiments, the threshold is a maximum distance of a location change of the first apparatus below which the TA value needs not adjusting.

In some example embodiments, the configuration information comprises at least one of the following: capability information indicative of a capability of the apparatus to support TA pre-compensation; random access configuration information at least comprising 2-step RA and 4-step RA; a reference signal received power (RSRP) threshold value; information enabling the first apparatus to determine the transmission TA; or condition information associated with RA selection.

In some example embodiments, the configuration information is received as part of a system information block, or broadcasting signals

In some example embodiments, the information enabling the first apparatus to determine the transmission TA comprises parameter information for the first apparatus to compute a propagation delay between the first apparatus and the second apparatus.

In some example embodiments, the parameter information comprises at least one of the following: positioning information of the second apparatus; TA values at different distances; TA values associated with different reference signal received power (RSRP) ranges; or timing synchronization information.

In some example embodiments, the condition information associated with RA selection comprises an indication indicating the RSRP threshold is able to be ignored if the TA pre-compensation capability is supported by the first apparatus, and the transmission of the message comprising the random access preamble and the uplink data is further in response to receiving the indication.

In some example embodiments, whether the difference between the current location of the first apparatus with its previous location is below the threshold is determined based on the positioning information of the second apparatus; and it is determined that the difference is below the threshold in response to the current location is within the distance of the threshold of its previous location.

In some example embodiments, the distance of the threshold is the granularity of the TA adjustment.

In some example embodiments, whether the difference between the current location of the first apparatus with its previous location is below the threshold is determined based on the TA value at the current location and the TA value at its previous location; and it is determined that the difference is below the threshold in response to the TA value at the current location is the same as the TA value at its previous location.

In some example embodiments, whether the difference between the current location of the first apparatus with its previous location is below the threshold is determined based on the TA values associated with different RSRP ranges; and it is determined that the difference is below the threshold in response to TA value at the RSRP level at the current location is the same as the RSRP level at its previous location.

In some example embodiments, the TA value of the previous location is obtained from the second apparatus while the first apparatus was in CONNECTED mode.

In some example embodiments, the first apparatus is in an IDLE mode or INACTIVE mode.

In some example embodiments, the first apparatus is or is comprised in a terminal device, and wherein the second apparatus is or is comprised in a network device.

FIG. 9 is a simplified block diagram of a device 900 that is suitable for implementing example embodiments of the present disclosure. The device 900 may be provided to implement a communication device, for example, the terminal device 110 or the network device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some example embodiments, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 922 and other volatile memories that will not last in the power-down duration.

A computer program 930 includes computer executable instructions that are executed by the associated processor 910. The instructions of the program 930 may include instructions for performing operations/acts of some example embodiments of the present disclosure. The program 930 may be stored in the memory, e.g., the ROM 924. The processor 910 may perform any suitable actions and processing by loading the program 930 into the RAM 922.

The example embodiments of the present disclosure may be implemented by means of the program 930 so that the device 900 may perform any process of the disclosure as discussed with reference to FIGS. 4-8. The example embodiments of the present disclosure may also be implemented by hardware or by a combination of software and hardware.

In some example embodiments, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

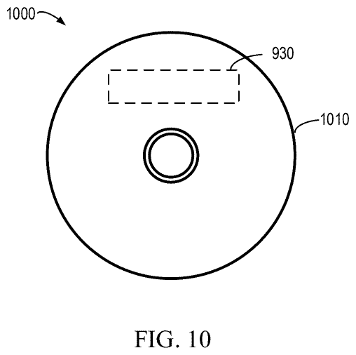

FIG. 10 shows an example of the computer readable medium 1000 which may be in form of CD, DVD or other optical storage disk. The computer readable medium 1000 has the program 930 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first apparatus comprising:
at least one processor; and
at least one memory storing instructions that, when executed by the at least one processor, cause the first apparatus at least to:
obtain configuration information associated with at least a timing advance (TA) pre-compensation capability;
determine whether a difference between a current location of the first apparatus with its previous location is below a threshold based on the configuration information; and
transmit, to a second apparatus, a message comprising a random access preamble and uplink data using a TA value of the previous location in response to the difference is below the threshold.

2. The first apparatus of claim 1, wherein first apparatus is caused to:
transmit the message comprising the random access preamble and the uplink data using the beam used by the first apparatus in its previous location.

3. The first apparatus of claim 1, wherein the threshold is a maximum distance of a location change of the first apparatus below which the TA value needs not adjusting.

4. The first apparatus of claim 1, wherein the configuration information comprises at least one of the following:
capability information indicative of a capability of the apparatus to support TA pre-compensation;
random access configuration information at least comprising 2-step RA and 4-step RA;
a reference signal received power (RSRP) threshold value;
information enabling the first apparatus to determine the transmission TA; or
condition information associated with RA selection.

5. The first apparatus of claim 1, wherein the configuration information is received as part of a system information block, or broadcasting signals

6. The first apparatus of claim 4, wherein the information enabling the first apparatus to determine the transmission TA comprises parameter information for the first apparatus to compute a propagation delay between the first apparatus and the second apparatus.

7. The first apparatus of claim 4, wherein the parameter information comprises at least one of the following:
positioning information of the second apparatus;
TA values at different distances;
TA values associated with different reference signal received power (RSRP) ranges; or timing synchronization information.

8. The first apparatus of claim 4, wherein the condition information associated with RA selection comprises an indication indicating the RSRP threshold is able to be ignored if the TA pre-compensation capability is supported by the first apparatus, and the transmission of the message comprising the random access preamble and the uplink data is further in response to receiving the indication.

9. The first apparatus of claim 7, wherein whether the difference between the current location of the first apparatus with its previous location is below the threshold is determined based on the positioning information of the second apparatus; and it is determined that the difference is below the threshold in response to the current location is within the distance of the threshold of its previous location.

10. The first apparatus of claim 9, wherein the distance of the threshold is the granularity of the TA adjustment.

11. The first apparatus of claim 7, wherein whether the difference between the current location of the first apparatus with its previous location is below the threshold is determined based on the TA value at the current location and the TA value at its previous location; and it is determined that the difference is below the threshold in response to the TA value at the current location is the same as the TA value at its previous location.

12. The first apparatus of claim 7, wherein whether the difference between the current location of the first apparatus with its previous location is below the threshold is determined based on the TA values associated with different RSRP ranges; and it is determined that the difference is below the threshold in response to TA value at the RSRP level at the current location is the same as the RSRP level at its previous location.

13. The first apparatus of claim 1, wherein the TA value of the previous location is obtained from the second apparatus while the first apparatus was in CONNECTED mode.

14. The first apparatus of claim 1, wherein the first apparatus is in an IDLE mode or INACTIVE mode.

15. (canceled)

15. (canceled)

16. (canceled)

17. A computer readable medium that is non-transitory and comprises instructions stored thereon for causing an apparatus at least to:
obtaining configuration information associated with at least a timing advance (TA) pre-compensation capability;
determining whether a difference between a current location of the first apparatus with its previous location is below a threshold based on the configuration information; and
transmitting, to a second apparatus, a message comprising a random access preamble and uplink data using a timing advance (TA) value of the previous location in response to the difference is below the threshold.

18. (canceled)

19. The first apparatus of claim 1, wherein the first apparatus is or is comprised in a terminal device, and wherein the second apparatus is or is comprised in a network device.

20. A method comprising:
obtaining configuration information associated with at least a timing advance (TA) pre-compensation capability;
determining whether a difference between a current location of the first apparatus with its previous location is below a threshold based on the configuration information; and
transmitting, to a second apparatus, a message comprising a random access preamble and uplink data using a timing advance (TA) value of the previous location in response to the difference is below the threshold.
